(19) United States
(12) Patent Application Publication
(10) Pub. No.: US 2013/0343214 A1
(43) Pub. Date: Dec. 26, 2013

(54) BASE STATION DEVICE, TERMINAL DEVICE, RADIO COMMUNICATION SYSTEM AND METHOD

(71) Applicant: SUMITOMO ELECTRIC INDUSTRIES, LTD., Osaka (JP)

(72) Inventors: Hirotsugu YAMAMOTO, Osaka (JP); Takashi YAMAMOTO, Osaka (JP); Youji OKADA, Osaka (JP); Kenichi MURAKAMI, Osaka (JP)

(73) Assignee: SUMITOMO ELECTRIC INDUSTRIES, LTD., Osaka (JP)

(21) Appl. No.: 13/939,287

(22) Filed: Jul. 11, 2013

Related U.S. Application Data
(63) Continuation of application No. PCT/JP2011/075421, filed on Nov. 4, 2011.

(30) Foreign Application Priority Data
Jan. 14, 2011 (JP) 2011-006259

(51) Int. Cl. H04W 72/08

(52) U.S. Cl. CPC H04W 72/085
USPC 370/252; 370/329; 370/331

(57) ABSTRACT

Appropriate communication is performed even before a CQI report is acquired. A base station device 1b that performs radio communication with a terminal device 2 includes: a report acquisition section that acquires the CQI report from the terminal device; and a selection section that selects a transmission state. The transmission state includes a first transmission state in which transmission is performed using a first radio resource subset A configured to include a radio resource that does not suffer interference from another base station device 1a, and a second transmission state in which transmission is performed using at least a second radio resource subset B configured to include a radio resource that is likely to suffer interference from another base station device 1b. The report acquisition section 14 acquires the CQI report of the second radio resource subset from the terminal device 2. The selection section 15 selects, based on the CQI report, either the first transmission state or the second transmission state, and selects the first transmission state before the CQI report is acquired.

### TECHNICAL FIELD

The present invention relates to a base station device, a terminal device, and a radio communication system and method.

### BACKGROUND ART

In conventional mobile communication systems, radio communication services have been provided by base station devices each forming a cell (macro cell) having a radius ranging from several hundreds of meters to several tens of kilometers.

In recent years, it has been expected that data communication traffic will dramatically increase with introduction of LTE (Long Term Evolution). Therefore, it is considered that a small base station device forming a cell (pico cell or the like) having a cell radius smaller than that of a macro cell is located in the range of the macro cell (refer to Non-Patent Literature 1).

It is possible to cope with the increasing traffic by causing a terminal device that performs a large amount of data communication to move from a macro cell to a pico cell, and perform communication from the pico cell.

### CITATION LIST

### Non Patent Literature

[NPL 1] 3GPP, “TS36.104 V10.0.0 Base Station (BS) radio transmission and reception”, 2010-09

### SUMMARY OF THE INVENTION

### Problems to be Solved by the Invention

Since a pico cell is located in the range of a macro cell, if the pico cell and the macro cell use the same communication frequency, a terminal device located near a cell edge of the pico cell might suffer strong interference from the macro cell.

That is, in an area near the cell center of the pico cell (near a small base station device forming the pico cell), a radio wave from the small base station device forming the pico cell is stronger than a radio wave from a base station device forming the macro cell. Accordingly, the communication quality of the terminal device in the pico cell is relatively favorable.

However, as getting away from the small base station device forming the pico cell, the radio wave from the small base station device is weakened. As a result, a terminal device located near the cell edge of the pico cell is more likely to suffer interference of the radio wave from the macro cell.

So, it is considered that, in a radio resource that the macro cell can use, an unused radio resource is provided. For example, it is considered that, in a frame to be transmitted by the macro cell, sections (blank subframes) in which the communication frequency is temporally unused are provided. When the macro cell side is in the blank subframes, the terminal device in the pico cell does not suffer interference from the macro cell side. Accordingly, the terminal device in the pico cell performs communication by using the blank subframes, and performs communication as little as possible in the sections in which the macro cell performs communication, thereby suppressing reduction in the communication quality due to interference from the macro cell. Thus, it is possible to suppress reduction in the communication quality even when the terminal device is located near the cell edge of the pico cell.

Further, it is also considered that, among frequencies (carriers) that the macro cell can use, an unused frequency (blank carrier) is provided. The terminal device in the pico cell performs communication by using the blank carrier, and uses as little as possible the carrier used for communication in the macro cell, thereby suppressing reduction in the communication quality even when the terminal device is located near the cell edge of the pico cell.

However, since interference from the macro cell is essentially small in the area near the cell center of the pico cell (near the small base station device forming the pico cell), even if the terminal device performs communication using the section or frequency used for communication in the macro cell, reduction in the communication quality causes no serious problem. Therefore, from a viewpoint of communication efficiency, the terminal device located near the cell center of the pico cell is encouraged to aggressively use, for communication, even the radio resource that is used for communication in the macro cell.

According to the above aspect, a radio resource suitable for use for communication by a terminal device depends on the location of the terminal device in the cell (distance from the base station device).

The base station device can recognize the location of the terminal device in the cell (distance from the base station device) by causing the terminal device to measure its communication quality and transmit the result to the base station device. However, in order to recognize the location of the terminal device in the cell (distance from the base station device) in this way, the base station device and the terminal device need to communicate with each other.

Therefore, before the terminal device establishes connection with the base station device, the base station device cannot recognize the location of the terminal device. If recognition of the location of the terminal device is delayed, start of communication between the base station device and the terminal device by using an appropriate radio resource will be delayed.

The present invention is made in connection with solution of the above-described problems.

### Solution to the Problems

(1) The present invention is a base station device that performs radio communication with a terminal device. The base station device includes: a report acquisition section that acquires, from the terminal device, a report relating to a measurement result of communication quality; and a selection section that selects a transmission state for the terminal device. The transmission state includes, at least, a first transmission state in which transmission is performed using a first radio resource subset configured to include one or a plurality of radio resources that do not suffer interference from another base station device, and a second transmission state in which transmission is performed using at least a second radio resource subset configured to include one or a plurality of radio resources that are likely to suffer interference from another base station device. The report acquisition section acquires, from the terminal device, a report relating to a measurement result of communication quality of one or a plurality of radio resource subsets including the second radio resource subset. When the report is acquired, the selection section selects, based on the report, either the first transmission state or the second transmission state as the transmission state for the terminal device. The selection section selects the first transmission state as the transmission state for the terminal device before the report is acquired.

According to the above-mentioned present invention, before the report is acquired, the first transmission state is selected, in which transmission is performed using the first radio resource subset configured to include one or a plurality of radio resources that do not suffer interference from another base station device. Accordingly, even if acquisition of the report is delayed, communication in the first transmission state in which the radio resource(s) is not likely to suffer interference is ensured before the report is acquired.

(2) Preferably, the base station device further includes a notification section that notifies subset information indicating one or a plurality of the radio resource subsets including the second radio resource subset, and the notification section notifies another base station device of the subset information, the another base station device being able to notify the terminal device of the subset information. In this case, it is possible to notify the terminal device of the subset information via the another base station device.

(3) Preferably, the base station device further includes a notification section that notifies subset information indicating one or a plurality of the radio resource subsets including the second radio resource subset, and during a handover process in which the terminal device performs handover to the base station device, the notification section notifies a source base station device in the handover process of the subset information. In this case, it is possible to notify the terminal device of the subset information via the source base station device during the handover process.

(4) Preferably, the notification section notifies the source base station device of the subset information by including the subset information in a message to be transmitted to the source base station device for the handover process. In this case, it is possible to notify the subset information by using the message for the handover process.

(5) Preferably, the message to be transmitted to the source base station device for the handover process is a response to a handover request transmitted from the source base station device.

(6) Preferably, the base station device further includes a notification section that notifies the terminal device of subset information indicating one or a plurality of the radio resource subsets including the second radio resource subset. In this case, the base station device can notify the terminal device of the second radio resource subset whose communication quality should be measured.

(7) Preferably, the notification section transmits the subset information as broadcast information.

(8) Preferably, the notification section notifies the terminal device of the subset information, during a connection establishment process for establishing connection between the terminal device and the base station device. In this case, the terminal device can acquire the subset information relatively early.

(9) Preferably, the notification section notifies the terminal device of the subset information by including the subset information in a message that is transmitted from the base station device to the terminal device in order to establish connection between the terminal device and the base station device. In this case, the terminal device can acquire the subset information relatively early.

(10) Preferably, in the second transmission state, transmission is performed by using the first radio resource subset and the second radio resource subset.

(11) Preferably, the radio resource is a time resource or a frequency resource.

(12) Preferably, the radio resource is a subframe or a carrier.

(13) Another aspect of the present invention is a terminal device that performs radio communication with a base station device. The terminal device includes: a measurement section that measures communication quality of a radio resource subset configured to include one or a plurality of radio resources that are likely to suffer interference from another base station device; a transmission section that transmits, to the base station device, a report relating to a measurement result by the measurement section; and a subset information acquisition section that acquires subset information indicating a radio resource subset whose communication quality should be measured by the measurement section.

(14) Preferably, the acquisition section acquires the subset information from the another base station device.

(15) Preferably, the acquisition section acquires the subset information from a source base station device in a handover process.

(16) Preferably, the subset information is included in broadcast information transmitted from the base station device, and the subset information acquisition section acquires the subset information by receiving the broadcast information from the base station device.

(17) Preferably, the measurement section measures communication quality of a radio resource subset indicated by the subset information included in the broadcast information that has been received in advance of a connection establishment process for establishing connection between the terminal device and the base station device, and the transmission section transmits the report during the connection establishment process.

(18) Preferably, the subset information is included in a message that is transmitted from the base station device to the terminal device in order to establish connection between the terminal device and the base station device, and the subset information acquisition section acquires the subset information by receiving the message from the base station device.

(19) Another aspect of the present invention is a radio communication system including a base station device, and a terminal device that performs radio communication with the base station device. The base station device includes: a report acquisition section that acquires, from the terminal device, a report relating to a measurement result of communication quality; and a selection section that selects a transmission state for the terminal device. The transmission state includes, at least, a first transmission state in which transmission is performed using a first radio resource subset configured to include one or a plurality of radio resources that do not suffer interference from another base station device, and a second transmission state in which transmission is performed using at least a second radio resource subset configured to include one or a plurality of radio resources that are likely to suffer interference from another base station device. The report acquisition section acquires, from the terminal device, a report relating to a measurement result of communication quality of one or a plurality of radio resource subsets including the second radio resource subset. When the report is acquired, the selection section selects, based on the report, either the first transmission state or the second transmission state as the transmission state for the terminal device. The selection section selects the first transmission state as the transmission state for the terminal device before the report is acquired.

(20) Preferably, the base station device further includes a notification section that notifies subset information indicating one or a plurality of the radio resource subsets including the second radio resource subset. The notification section notifies another base station device of the subset information, the another base station device being able to notify the terminal device of the subset information. The another base station device notifies the terminal device of the subset information.

(21) Another aspect of the present invention is a method performed by a base station device to select a transmission state. The transmission state includes, at least, a first transmission state in which transmission is performed using a first radio resource subset configured to include one or a plurality of radio resources that do not suffer interference from another base station device, and a second transmission state in which transmission is performed using at least a second radio resource subset configured to include one or a plurality of radio resources that are likely to suffer interference from another base station device. The base station device selects the first transmission state as the transmission state for the terminal device before acquiring, from the terminal device, a report relating to a measurement result of communication quality of one or a plurality of radio resource subsets including the second radio resource subset, and upon acquiring the report, selects, based on the report, either the first transmission state or the second transmission state as the transmission state for the terminal device.

(22) Another aspect of the present invention is a method for transmitting information from a base station device to a terminal device. The information is subset information indicating a radio resource subset configured to include one or a plurality of radio resources to be a target of measurement of communication quality by the terminal device. The base station device notifies another base station device of the subset information, the another base station device being able to notify the terminal device of the subset information. The another base station device transmits the subset information to the terminal device.

### BRIEF DESCRIPTION OF THE DRAWINGS

FIG. 1 is a configuration diagram of a communication system.

FIG. 2 is a configuration diagram of an inter-base-station network.

FIG. 3 is a diagram showing structures of a DL frame and a UL frame.

FIG. 4 is a diagram showing the structure of the DL frame.

FIG. 5A is a diagram showing inter-cell interference between a macro BS and a pico BS.

FIG. 5B is a diagram showing inter-cell interference between a macro BS and a pico BS.

FIG. 5C is a diagram showing inter-cell interference between a macro BS and a pico BS.

FIG. 6 is a diagram showing examples of combination patterns of subsets.

FIG. 7A is a configuration diagram of a base station device (pico BS).

FIG. 7B is a configuration diagram of a terminal device.

FIG. 8 is a sequence showing a procedure for selecting a transmission state.

FIG. 9 is a diagram showing a method for acquiring ABS information.

FIG. 10 is a sequence for selecting a transmission state.

FIG. 11 shows a specific example of subset information.

FIG. 12 shows a specific example of RadioResourceConfigDedicated.

FIG. 13 shows a second example of a sequence for selecting a transmission state.

FIG. 14 is a diagram showing handover from a macro cell to a pico cell.

FIG. 15 is a sequence for selecting a transmission state during handover.

FIG. 16 is a sequence for selecting a transmission state during handover.

### DESCRIPTION OF EMBODIMENTS

Hereinafter, preferred embodiments of the present invention will be described with reference to the drawings.

### 1. Configuration of Communication System

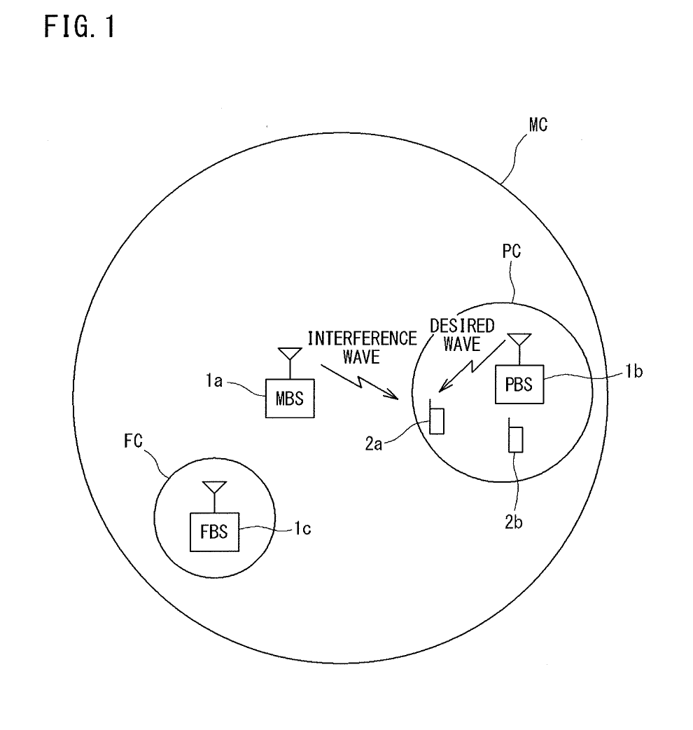

FIG. 1 is a schematic diagram showing a configuration of a radio communication system. This communication system is a cellular type system including a plurality of base station devices (BS; Base Station) 1. The radio communication system of the present embodiment is, for example, a system to which LTE is applied, and communication based on LTE is performed between each base station device 1 and a terminal device (UE; User Equipment) 2. However, the communication scheme is not limited to LTE.

The plurality of base station devices 1 constituting the communication system may include, for example, a plurality of macro base station devices (Macro Base Stations) la each forming a communication area (macro cell) MC having a size of several kilometers, and small base station devices 1b and 1c each forming a cell smaller than the macro cell. Examples of the small base station devices may include: a pico base station device 1b forming a pico cell PC, and a femto base station device 1c forming a femto cell FC.

Hereinafter, the macro base station device is referred to as a macro BS, the pico base station device as a pico BS, and the femto base station device as a femto BS.

One or a plurality of pico BSs 1b are installed in a macro cell. Each pico BS 1b is installed mainly by a telecommunications carrier, as in the case of the macro BS 1a. By connecting a terminal device (mobile terminal) 2 in the macro cell MC not to the macro BS la but to the pico BS 1b, the communication load on the macro BS 1a is reduced, thereby improving the throughput of the entire system.

One or a plurality of femto BSs 1c are also installed in the macro cell. Each femto BS 1c is installed mainly by an individual or a company that is a customer (user) of the communication system. The femto BS 1c thus installed allows, for example, improvement of communication environment in the place where it is installed.

The femto cell FC and the pico cell PC each have a communication area narrower than the macro cell MC, and generally, the femto cell FC is narrower than the pico cell PC as indicated by their names “femto” and “pico”.

In LTE, a macro BS and a pico BS are referred to as “eNB”, and a femto BS is referred to as “HeNB”.

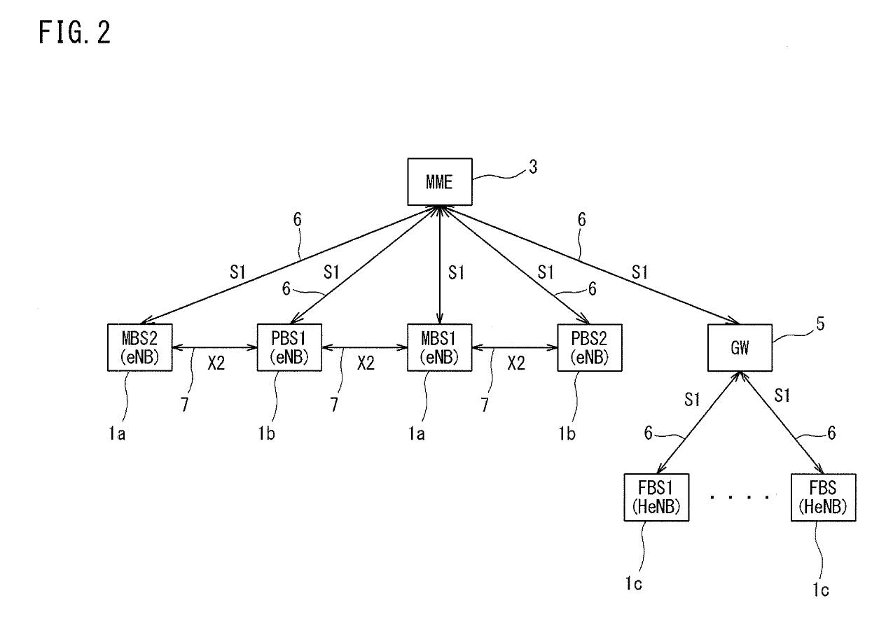

FIG. 2 shows an inter-base-station network (wired network) in which base station devices including macro BSs 1a, pico BSs 1b, and femto BSs 1c are connected. Each macro BS 1a and each pico BS 1b, i.e., each eNB, are connected to an MME (Mobility Management Entity) via a line 6 using a communication interface called “S1 interface”. The MME 3 is a management device that manages the locations and the like of terminal devices 2, and is a node that performs a process of mobility management for each terminal device 2.

Further, the respective eNBs are connected to each other by a line 7 using a communication interface called “X2 interface”, and are allowed to communicate with each other to directly exchange information. However, in the current standard, a femto BS 1c cannot have the X2 interface.

Connection using the X2 interface is not limited to that shown in FIG. 2, and the X2 interface may be provided between any two eNBs.

Each femto BS 1c as an HeNB is connected to the MME 3 via an HeNB gateway (GW) 5. Connection between the MME 3 and the gateway 5 and connection between the gateway 5 and the femto BS 1c are also achieved by a line 6 using the communication interface called “S1 interface”.

The femto BS 1c may be connected to the MME 3 by the S1 interface without an intervening HeNB gateway (GW) 5.

The above-mentioned network using the S1 interface and the X2 interface forms an inter-base-station network in which the respective base station devices 1a, 1b, and 1c are wire-connected. In the inter-base-station network, a server for managing communication (not shown) and the like are installed.

Between the respective base station devices 1a, 1b, and 1c, inter-base-station synchronization is ensured by using an inter-base-station network or the like.

### 2. Frame Structure for LTE

In an FDD scheme that can be adopted in LTE with which the communication system of the present embodiment complies, uplink communication and downlink communication are simultaneously performed by allocating different operating frequencies to an uplink signal (a transmission signal from a terminal device to a base station device) and a downlink signal (a transmission signal from the base station device to the terminal device).

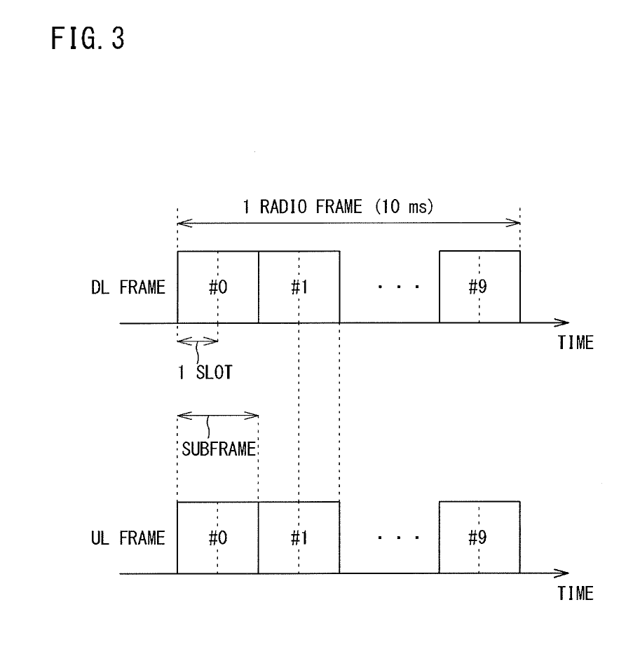

FIG. 3 is a diagram showing the structures of uplink and downlink radio frames for LTE. Each of a downlink radio frame (DL frame) and an uplink radio frame (UL frame), which are the essential frames for LTE, has a time length of 10 milliseconds per radio frame, and consists of 10 subframes #0 to #9 (each subframe is a communication unit area having a constant time length). The DL frame and the UL frame are arranged in the time-axis direction with their timings coinciding with each other.

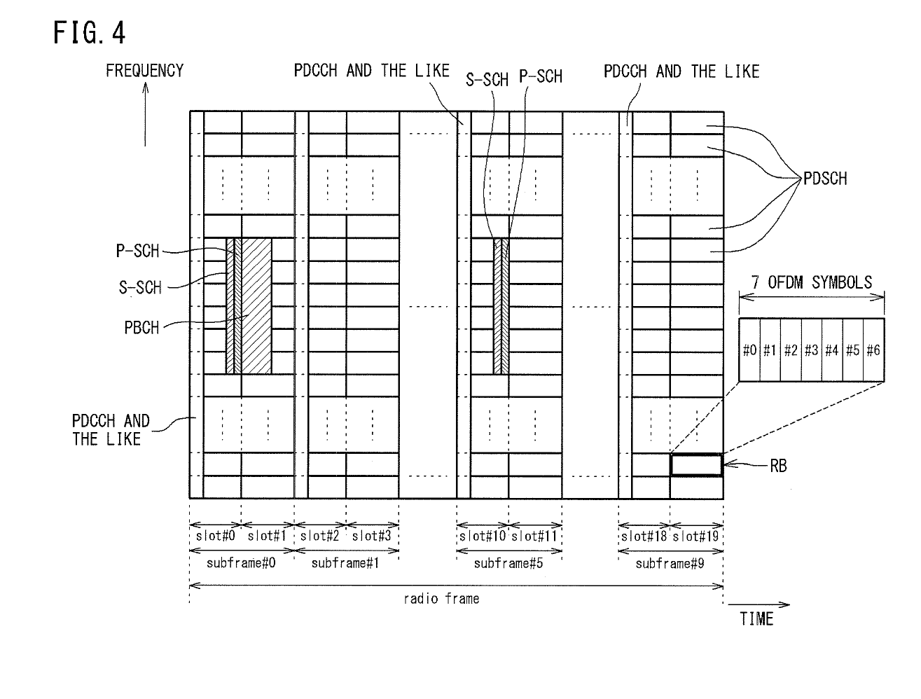

FIG. 4 is a diagram showing the structure of the DL frame (a transmission frame from a base station device) in detail. In FIG. 4, the vertical axis direction indicates the frequency, and the horizontal axis direction indicates the time.

Each of subframes forming the DL frame consists of 2 slots. Each slot consists of 7 (#0 to #6) OFDM symbols (in the case of Normal Cyclic Prefix).

Further, in FIG. 4, a resource block (RB) that is a fundamental unit area for data transmission is defined by 12 subcarriers in the frequency-axis direction and 7 OFDM symbols (1 slot) in the time-axis direction.

Further, for the bandwidth of the DL frame in the frequency direction, a plurality of set values are provided up to the maximum of 20 MHz.

As shown in FIG. 4, at the beginning of each subframe, a transmission area is secured in which a base station device 1 allocates, to a terminal device 2, a control channel required for downlink communication. This transmission area corresponds to symbols #0 to #2 (three symbols at maximum) in the front-side slot in each subframe. PDCCH, PCFICH, PHICH, and the like are allocated to this transmission area.

Among the 10 subframes forming the DL frame, the 1st (#0) and 6th (#5) subframes are each given a primary synchronization channel (P-SCH) and a secondary synchronization channel (S-SCH) which are control signals for identifying a base station device or a cell.

In the DL frame, a physical broadcast channel (PBCH) for notifying, by broadcasting, terminal devices of the frequency bandwidth and the like of the system, is allocated to the first subframe #0. The PBCH is arranged, in the time-axis direction, in the position corresponding to symbols #0 to #3 in the rear-side slot in the first subframe #0 so as to have a width corresponding to 4 symbols, and arranged, in the frequency-axis direction, in the center of the bandwidth of the DL frame so as to have a width corresponding to 6 resource blocks (72 subcarriers). The PBCH is configured to be updated every 40 milliseconds by transmitting the same information over 4 frames.

The PBCH has, stored therein, master information blocks (MIB) containing the communication bandwidth, the radio frame number, and the like.

Other resource blocks in which the above-described channels are not allocated are used as a physical downlink shared channel (PDSCH) in which user data and the like are stored. The PDSCH is an area shared by a plurality of terminal devices.

Allocation of the user data stored in the PDSCH is notified to terminal devices by means of resource allocation information relating to downlink radio resource allocation, which is stored in the PDCCH allocated at the beginning of each subframe. The resource allocation information is information indicating radio resource allocation to each PDSCH, and allows each terminal device to know that data directed to the terminal device is stored in the subframe.

The P-SCH, S-SCH, PBCH, PDCCH, and other control channels include various kinds of control signals required by each terminal device 2 to receive the data signal transmitted by the PDSCH. Therefore, if these control channels are subjected to radio wave interference, reception of the data signal transmitted by the PDSCH is adversely affected.

Further, in addition to the user data, a control signal common to the respective terminal devices, control signals specific to the respective terminal devices, and the like are also stored in the PDSCH. Examples of the control signals stored in the PDSCH include, for example, broadcast information such as system information blocks (SIB).

Examples of the system information blocks include SIB1 to SIB9. The timing at which the SIB1 is transmitted or the like is specified in the MIB. Scheduling information of the SIB2 to SIB9 is included in the SIB1. Therefore, even if the terminal device 2 has not established connection with the base station device 1, the terminal device can read the broadcast information such as the SIBs. The number of the SIBs is not particularly limited.

### 3. Inter-Cell Interference

As shown in FIG. 1, a radio wave (interference wave) from the macro BS 1a easily arrives at the terminal device 2a located near the cell edge of the pico cell PC, and moreover, the intensity of a radio wave (desired wave) from the pico BS 1b is weak at the cell edge. Therefore, the terminal device 2a is likely to suffer interference from the macro BS 1a.

Since a relatively strong radio wave from the pico BS 1b arrives at the terminal device 2b located near the cell center of the pico cell PC (near the pico BS 1b), the terminal device 2b is less likely to suffer interference from the macro BS 1a.

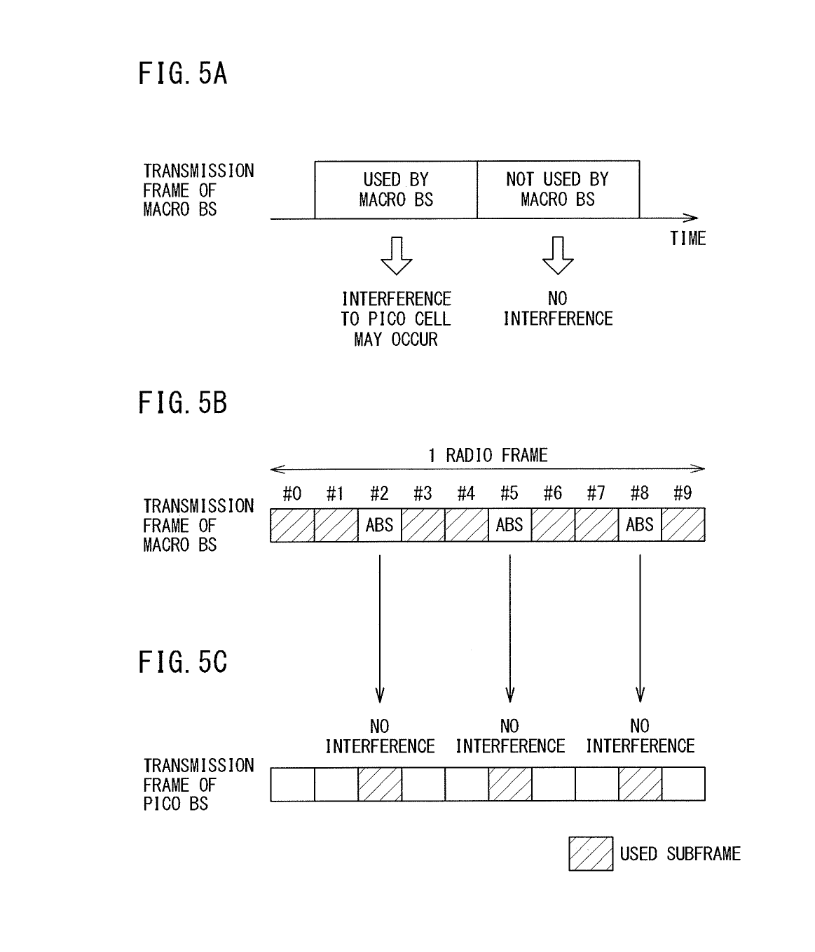

In order to reduce such interference from the macro BS 1a to the terminal device 2 located near the cell edge of the pico cell PC, an unused radio resource may be secured in a radio resource that the macro BS 1a can use. For example, as shown in FIG. 5(a), a section (a time period as a radio resource) in which the macro BS 1a does not use the communication frequency may be provided in a transmission frame of the macro BS 1a. The pico BS 1b performs, in the section not used by the macro BS 1a, transmission to the terminal device 2a connected to the pico BS 1b, thereby eliminating interference from the macro BS 1a.

The unused radio resource may be a frequency. For example, an unused frequency (blank carrier) may be secured in a frequency (carrier) that the macro BS 1a can use. The pico BS 1b performs, with the frequency (blank carrier) not used by the macro BS 1a, transmission to the terminal device 2a connected to the pico BS 1b, thereby eliminating interference from the macro BS 1a.

In the following description, a subframe is used as an example of the radio resource. However, the following description is also applicable to a case where the radio resource is a frequency (carrier).

FIG. 5(b) shows a case where ABSs (Almost Blank Subframes) are provided in a transmission frame of the macro BS 1a, as a specific example of providing sections in which the macro BS 1a does not use the communication frequency. Each ABS is a blank subframe that includes a reference signal (CRS; Cell-specific Reference Signal) and/or other minimum necessary control signals, but does not include a data signal (PDSCH).

As shown in FIG. 5(c), subframes of the pico BS 1b at timings corresponding to the ABSs of the macro BS 1a are subframes that do not suffer interference from the macro BS 1a. Accordingly, the pico BS 1b performs transmission by using the subframes at the timings corresponding to the ABSs of the macro BS 1a, thereby avoiding interference from the macro BS 1a to the terminal device 2a connected to the pico BS 1b.

Accordingly, the pico BS 1b performs transmission, to the terminal device 2a located near the cell edge of the pico cell, by using subframe subsets containing many subframes at the timings corresponding to the ABSs of the macro BS 1a, thereby reducing influence of interference from the macro BS 1a.

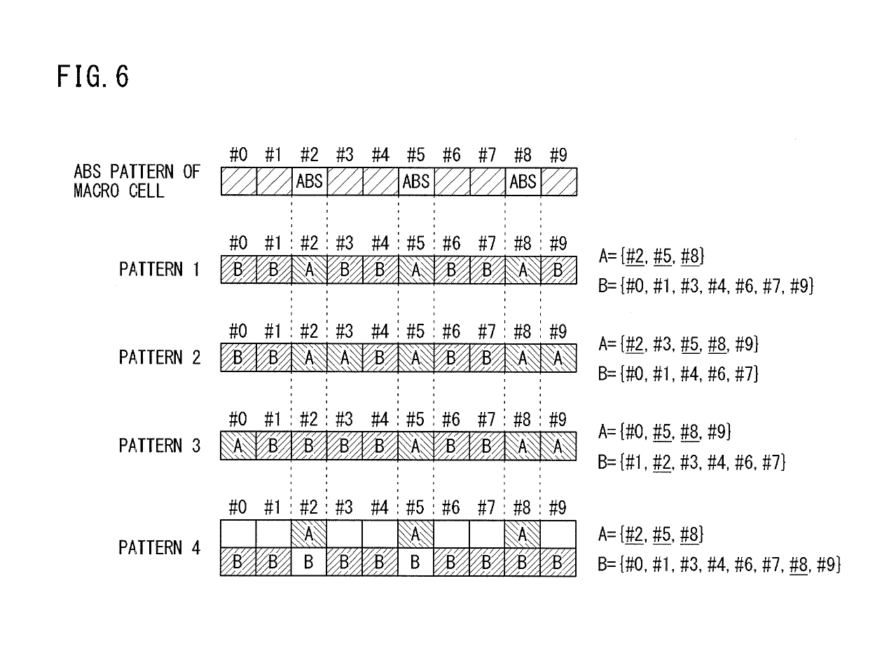

FIG. 6 shows examples of patterns in which one radio transmission frame is constituted by using two subsets A and B. Each subset is a subframe subset having subframes as elements. Each of subframes (#0 to #9) constituting one radio transmission frame belongs to either (or both) of the two subsets A and B.

In pattern 1, subframes #2, #5, and #8 belong to the first subframe subset A, and subframes #0, #1, #3, #4, #6, #7, and #9 belong to second subframe subset B. When the macro-cell-side ABSs are provided at #2, #5, and #8, the pico BS 1b performs transmission by using the subframes #2, #5, and #8 that belong to the first subframe subset A, thereby avoiding interference from the macro cell even when the terminal device 2a is located near the cell edge.

On the other hand, when the terminal device 2b connected to the pico BS 1b is located near the center of the pico cell (near the pico BS 1b), interference from the macro cell side is small even when the pico BS 1b performs transmission by using the subframes #0, #1, #3, #4, #6, #7, and #9 that belong to the second subframe subset B, or the entire frame (#0 to #9).

As described above, when the ABS pattern on the macro cell side is as shown in FIG. 6, the first subframe subset A is suitable for transmission to the terminal device 2a located near the cell edge, and the second subframe subset B or the entire frame is suitable for transmission to the terminal device 2b located near the center of the pico cell.

Accordingly, the pico BS 1b determines the subframes to be used for transmission to the terminal device 2b in accordance with the location of the terminal device 2b (whether it is near the cell edge or the cell center), thereby reducing interference.

Although in FIG. 6 the subframe numbers (#0 to #9) of the macro cell and the subframe numbers (#0 to #9) of the pico cell temporally coincide with each other, the frame numbers need not coincide with each other. In addition, although in FIG. 6 each pattern of the subsets A and B is defined by only 10 subframes included in one frame, the pattern may be defined by a plurality of frames (e.g., 40 subframes corresponding to 4 frames).

The example of the two subsets A and B constituting one radio transmission frame is not limited to the pattern 1. A plurality of patterns, such as patterns 2 to 4, may be provided as shown in FIG. 6.

Providing the plurality of patterns makes it possible to appropriately select a suitable pattern in accordance with the ABS pattern (the ABS positions in the frame) on the neighboring macro cell side.

Like the patterns 1 to 4 shown in FIG. 6, the number of subframes constituting each of the subsets A and B is not particularly limited. In addition, like the pattern 4, a subframe may belong to both the two subsets A and B (refer to the subframe #8 in the pattern 4).

Further, the number of subsets is not limited to 2, but may be 3 or more.

In the case of the ABS pattern of the macro cell shown in FIG. 6, in the patterns 1 to 4 shown in FIG. 6, the percentage of the subframes corresponding to the ABSs (#2, #5, and #8) of the macro cell is higher in the subset A than in the subset B. That is, the subset A is the first subframe subset configured to include one or a plurality of subsets which do not suffer interference from the macro BS 1a.

Further, in the case of the ABS pattern of the macro cell shown in FIG. 6, in the patterns 1 to 4, the subset B is the second subframe subset configured to include one or a plurality of subsets among the subsets (#0, #1, #3, #4, #6, #7, and #9) that are likely to suffer interference from the macro BS 1a.

Besides the ABS, the blank subframe may be a subframe (MBSFN) for MBMS (Multimedia Broadcast Multicast Service). The MBMS is a broadcast service such as a TV broadcast service, in which the same information is transmitted from a plurality of base station devices at the same timing by using the same resource.

Since the MBMS is the broadcast service, in an MBSFN subframe used for the MBMS, besides information relating to the MBMS, minimum necessary control information indicating, for example, that the subframe is an MBSFN subframe, is transmitted by using a control channel (2 symbols on the front side of the subframe), and control information directed to a specific terminal device is not transmitted.

In the present embodiment, since the MBSFN subframe is used as a blank subframe, a null signal is set as a data signal in the MBSFN subframe transmitted by the macro BS 1a. The MBSFN subframe for transmitting the null signal need not include a reference signal, and therefore, is more likely to be a perfect blank subframe as compared to the ABS.

As described above, the blank subframe (the section in which the communication frequency is not used) need not be a subframe in which no signal exists at all, and may be a subframe in which a blank having no signal exists substantially.

Alternatively, the blank subframe may be a subframe which is actually used but in which the signal power is reduced, and therefore, is substantially regarded as an unused subframe when it is sufficiently distant from the base station device.

### 4. Configurations of Base Station Device and Terminal Device

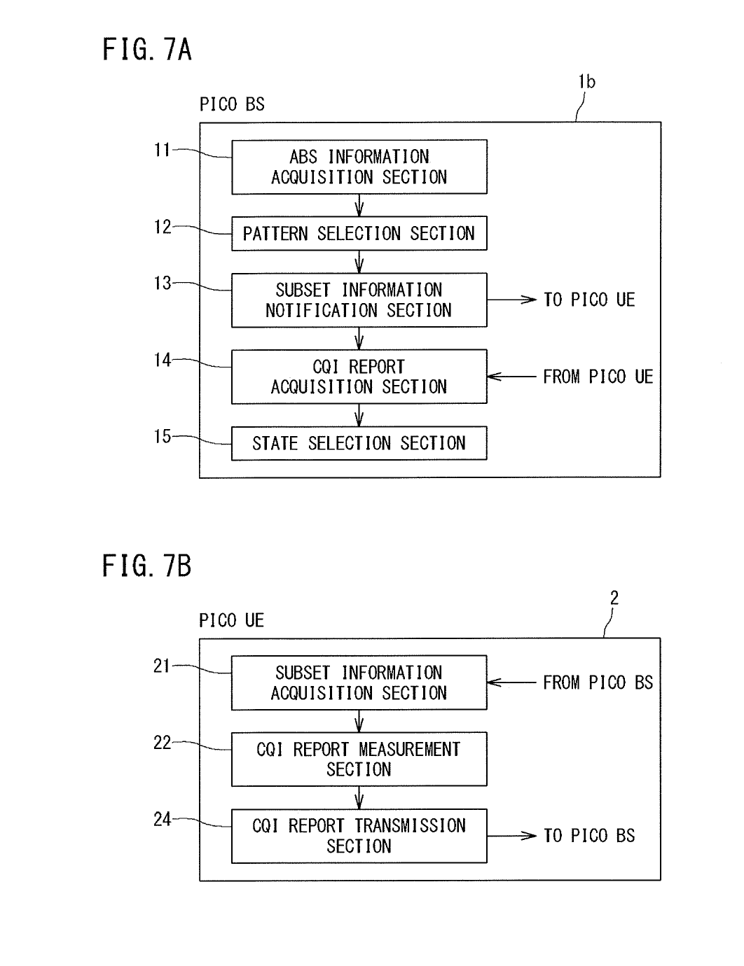

FIG. 7(a) shows the configuration of the pico BS 1b, and FIG. 7(b) shows the configuration of the terminal device 2. The femto BS 1c may have the configuration shown in FIG. 7(a).

The pico BS 1b includes an ABS information acquisition section 11, a pattern selection section 12, a subset information notification section 13, a CQI report acquisition section 14, and a selection section 15.

The ABS information acquisition section 11 acquires, from the macro BS 1a (another base station device), information (ABS information) indicating the positions of ABSs (blank subframes) in a transmission frame transmitted by the macro BS 1a (another base station device).

The pattern selection section 12 selects a pattern indicating a combination of two subsets A and B. The subset information notification section 13 notifies the terminal device 2 of information (subset information) about the subframe subsets A and B in the pattern selected by the pattern selection section 12.

The subset information is information that allows the terminal device 2 to specify at least subframes constituting the second subframe subset B. The subset information may include information that allows the terminal device 2 to specify subframes constituting the first subframe subset A.

The CQI report acquisition section 14 acquires a CQI (Channel Quality Indicator) report from the terminal device (UE) 2.

The CQI report relates to a measurement result of communication quality that is measured by the terminal device 2 with respect to the subset(s) constituting the second subframe subset B. In addition, the CQI report may include a measurement result of communication quality that is measured with respect to the subset(s) constituting the first subframe subset A.

The state selection section 15 selects a transmission state based on the CQI report acquired by the CQI report acquisition section 14.

The transmission state includes a first transmission state and a second transmission state. The selection section 15 selects one of the first transmission state and the second transmission state. The pico BS 1b performs transmission in the selected transmission state. The transmission state may include other transmission states than the first transmission state and the second transmission state.

In the first transmission state, transmission is performed by using the first subframe subset A configured to include one or a plurality of subframes that do not suffer interference from the macro BS 1a.

In the second transmission state, transmission is performed by using only the second subframe subset B configured to include subframes that are likely to suffer interference from the macro BS 1a, or using both the first subframe subset A and the second subframe subset B.

If the CQI of the second subframe subset B measured by the terminal device 2 is not good, it is determined that interference from the macro cell is great, and the terminal device 2 that has measured the CQI is located near the cell edge of the pico cell PC. Accordingly, the state selection section 15 selects the first transmission state.

On the other hand, when the CQI (communication quality; channel quality) of the second subframe subset B measured by the terminal device 2 is good, it is determined that interference from the macro cell is small, and the terminal device 2 that has measured the CQI is located near the center of the pico cell PC. Accordingly, the state selection section 15 selects the second transmission state.

The determination as to whether or not the CQI of the second subframe subset B is good can be performed by comparing the CQI with a threshold indicating whether or not the CQI is good.

If the CQI measurement result of the first subframe subset A has also been acquired, the CQIs of the subsets A and B may be compared with each other. The state selection section 15 can select the state in which the subset having the better CQI is used.

Further, when a difference between the CQIs of the subsets A and B is equal to or larger than a predetermined value, the state selection section 15 may select the state in which only the subset having the better CQI is used. When the difference is smaller than the predetermined value, the state selection section 15 may select the state in which only the subset having the worse CQI is used. The reason is as follows. When the difference between the CQIs of the subsets A and B is small, it can be determined that the terminal device 2 is present in the center of the pico cell PC. Then, it is expected that many terminal devices 2 want to use the subset used by the terminal device 2 located near the cell edge, which might cause congestion. So, when the difference is smaller than the predetermined value, only the subset having the worse CQI is used to avoid such congestion.

Further, the state selection section 15 may perform the state selection such that the subset whose CQI is equal to or smaller than the predetermined value is not used for transmission, and only the ABS subset whose CQI is equal to or larger than the predetermined value is used. In this case, when the CQIs of the plurality of subsets are all equal to or larger than the predetermined value, the plurality of subsets may be used simultaneously.

The terminal device 2 includes a subset information acquisition section 21, a CQI measurement section 22, and a CQI report transmission section 24.

The subset information acquisition section 21 acquires subset information from the base station device (pico BS 1b) to which the terminal device 2 is connected.

The CQI measurement section 22 measures the CQIs of the subframes constituting the second subframe subset B, based on the subset information acquired by the subset information acquisition section 21. The CQI measurement section 22 may measure the CQIs of the subframes constituting the first subframe subset A, or the CQI of the entire frame.

The CQI report transmission section 24 transmits a report (CQI report) relating to the result of the measurement performed by the CQI measurement section 22 to the base station device (pico BS 1b). The CQI report includes the measurement result of the second subframe subset B, the measurement result of the first subframe subset A, and/or the measurement result of the entire frame.

### 5. Basic Idea of Transmission State Selection Process for Avoiding Interference

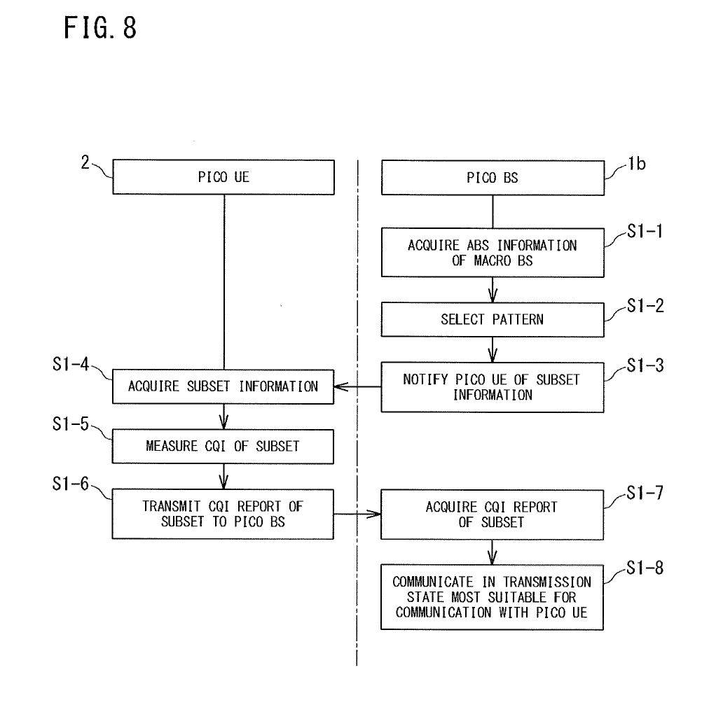

FIG. 8 shows a procedure in which the pico BS 1b selects an appropriate transmission state in order to avoid interference from the macro cell.

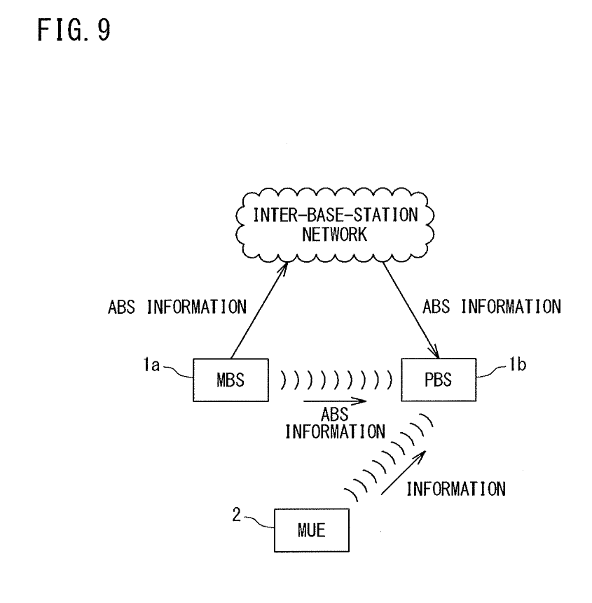

First, the ABS information acquisition section 11 of the pico BS 1b acquires the ABS information of the macro BS (step S1-1). As shown in FIG. 9, the ABS information can be acquired from the macro BS 1a via the inter-base-station network. Alternatively, the pico BS 1b may acquire the ABS information from the macro BS 1a by radio communication, or may acquire the ABS information from the terminal device (MUE) 2 connected to the macro BS 1a by radio communication.

Subsequently, based on the acquired ABS information, the pattern selection section 12 determines two subframe subsets A and B (pattern selection; step S1-2). The determination is performed such that the first subframe subset A mainly includes one or a plurality of subframes at timings corresponding to the ABSs of the macro cell, and the second subframe subset B mainly includes one or a plurality of subframes at timings other than the timings corresponding to the ABSs of the macro cell.

The subset information notification section 13 transmits subset information indicating the first and second subframe subsets A and B determined by the pattern selection section 12, to the terminal device (pico UE) 2 in the pico cell PC (step S1-3).

The subset information acquisition section 21 of the terminal device (pico UE) 2 acquires the subset information notified by the pico BS 1b (step S1-4).

The CQI measurement section 22 performs CQI measurement in the subframes constituting the second subframe subset B (step S1-5). The CQI measurement is performed for each of the subframes constituting the second subframe subset B, and an average of the measurement results of the respective subframes is the CQI of the second subframe subset B.

The CQI report transmission section 24 wirelessly transmits the CQI measurement result of the second subframe subset B as the CQI report to the pico BS 1b (step S1-6).

The CQI report acquisition section 14 of the pico BS 1b receives the CQI report transmitted from the terminal device 2 (step S1-7).

Based on the acquired CQI report, the state selection section 15 selects an appropriate transmission state between the first transmission state and the second transmission state, and the pico BS 1b performs transmission in the selected transmission state to the terminal device 2 that has transmitted the CQI report.

### 6. Specific Procedure of Transmission State Selection Process

### 6.1 Example 1

According to the procedure shown in FIG. 8, the pico BS 1b can select an appropriate transmission state after communication for subset information notification or the like has been performed between the pico BS 1b and the terminal device 2. That is, transmission from the pico BS 1b to the terminal device 2 is performed even before the pico BS 1b acquires the CQI report (step S1-7) and performs selection of an appropriate transmission state (step S1-8).

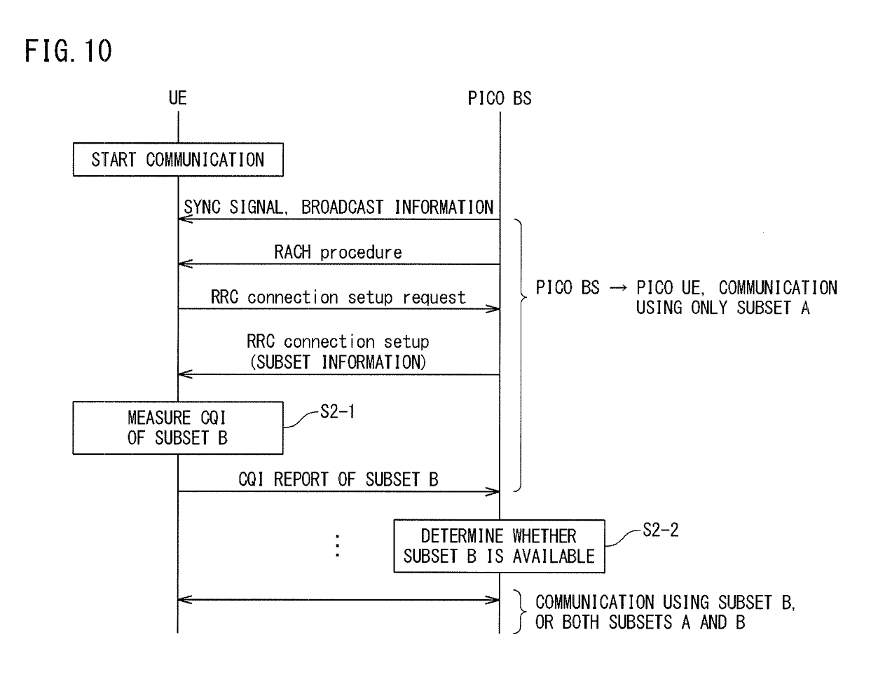

In the present embodiment, in order to optimize the transmission before the acquisition of the CQI report, the transmission before the acquisition of the CQI report is performed in the first transmission state using the first subframe subset A as shown in FIG. 10.

As shown in FIG. 10, transmission from the pico BS 1b to the terminal device 2, such as RACH Procedure or RRC Connection Setup, is performed in the first transmission state using only the first subframe subset A.

The RACH Procedure performs uplink timing synchronization, and determination/notification of an user ID (C-RNTI) required for PHY layer communication. The RRC Connection Setup notifies whether or not a communication channel (Radio Bear) between the terminal device and the base station device is available, and config. information of the channel.

Further, in the present embodiment, the RRC Connection Setup includes config. information (TS36.331 CQI-Report Config) relating to the CQI report, and the terminal device 2 is allowed to transmit the CQI report to the base station device after acquisition of the config. information.

The RRC Connection Request is a request for establishment of RRC layer connection which enables communication between the terminal device and the base station device, and is a message relating to radio connection control.

In FIG. 10, CQI measurement by the CQI measurement section 22 of the terminal device 2 is performed after the connection (RRC Connection) establishment process (radio connection control) (step S2-1). After the CQI report has been acquired from the terminal device 2, the state selection section 15 of the pico BS 1b selects either the first transmission state or the second transmission state (step S2-2). In step S2-2 in FIG. 10, the selection by the selection section 15 is shown as determination whether or not use of the second subframe subset B is allowed (whether or not the second transmission state is allowed).

After acquisition of the CQI report, when the selection section 15 has determined that the second subframe subset B can be used, based on the acquired CQI report, the selection section 15 selects the second subframe subset B. That is, the terminal device 2 performs communication by using only the second subframe subset B, or using both the first and second subframe subsets A and B.

On the other hand, when the state selection section 15 has determined that the second subframe subset B cannot be used, the state selection section 15 selects the first transmission state.

As described above, before the state selection section 15 performs selection based on the CQI report, the state selection section 15 automatically selects the first transmission state before it acquires the CQI report. Accordingly, transmission using only the first subframe subset A is performed during the connection establishment process, and before the CQI report is acquired after the connection has been established.

The reason is as follows. That is, when the terminal device 2 attempts to establish connection with the base station device, the base station device cannot recognize the location of the terminal device 2 before acquiring the CQI report. While the base station device cannot recognize the location of the terminal device 2, it is preferable to regard that the terminal device 2 is located near the cell edge where the terminal device 2 is more likely to suffer interference.

So, before the CQI report is acquired, the state selection section 15 of the pico BS 1b regards that the terminal device 2 is located near the cell edge without depending on the CQI report, and selects the first transmission state using the first subframe subset A for the cell edge and its vicinity.

Further, as shown in FIG. 10, the subset information notification section 13 includes the subset information in a message (message for radio connection control, such as RRC Connection Setup) to be transmitted from the pico BS 1b to the terminal device 2 for the connection establishment process between the terminal device 2 and the pico BS 1b, and then transmits the message. Thereby, the subset information acquisition section 21 of the terminal device 2 can acquire the subset information in association with reception of the message during the connection establishment process, and thus CQI measurement by the terminal device 2 can be performed relatively early.

As described above, in the present embodiment, when notifying the subset information from the pico BS 1b to the terminal device 2, passing of the information is performed by RRC layer transmission (Signaling) between the pico BS 1b and the terminal device 2.

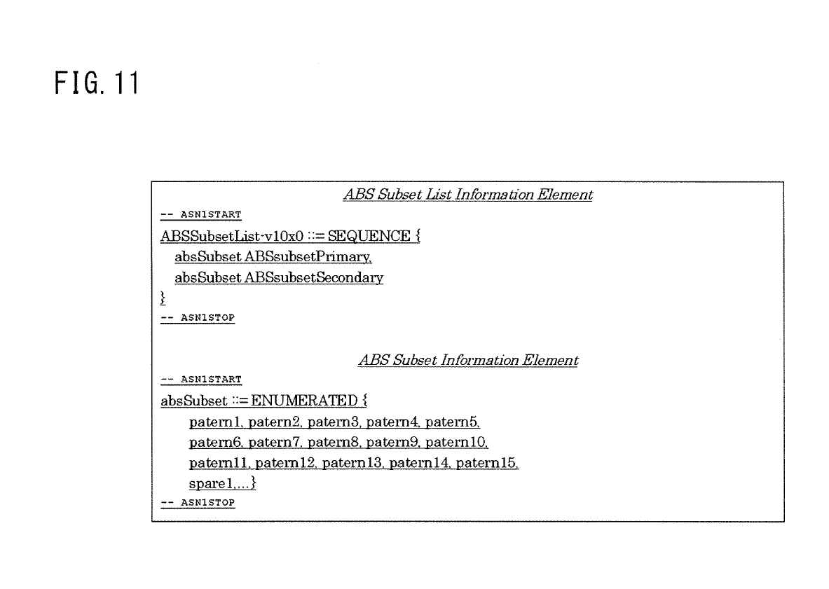

FIG. 11 shows a specific example of an IE (Information Element) indicating the subset information. In FIG. 11, a subframe subset is represented by a name “ABS Subset”.

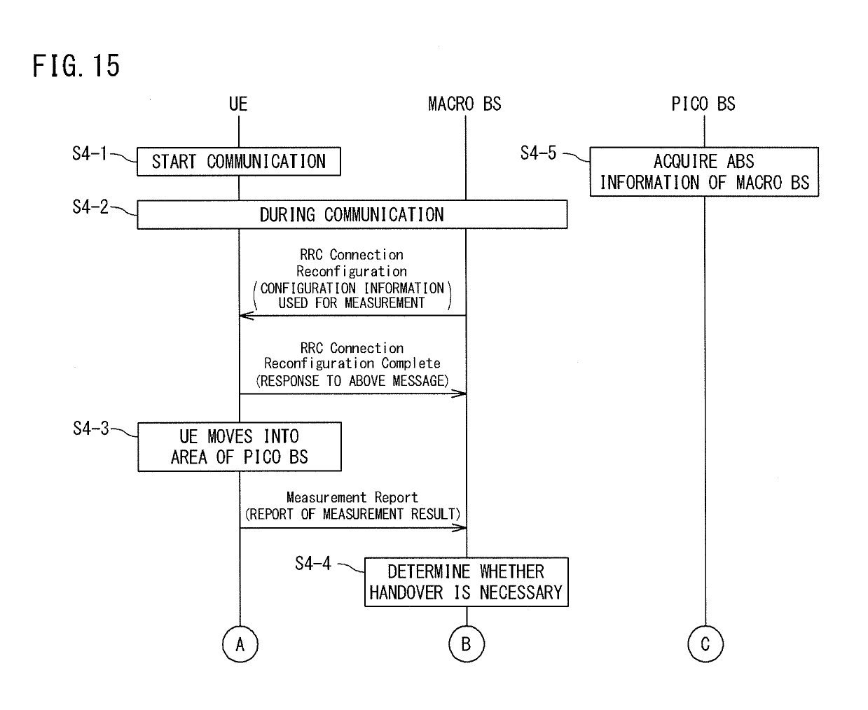

The part of “ABS Subset Information Element” in FIG. 11 defines an IE “absSubset”. In the “absSubset”, one of a plurality of subframe subset patterns (in FIGS. 11, 15 patterns; patern1 to patarn15) is designated. The “patterns” described here are different from the patterns (combinations of subsets) shown in FIG. 6, but are different patterns of subframes constituting one subframe subset. That is, subframes constituting one subframe subset are specified by the patterns shown in FIG. 11. In the “absSubset”, subframes constituting one subframe subset may be designated by a bit map or the like.

The part of “ABS Subset List Information Element” in FIG. 11 defines an IE “ABSSubsetList-v10x0”. In the “ABSSubsetList-v10x0”, a combination of the first subframe subset A and the second subframe subset B is designated. Here, for example, the “absSubset” serving as the first subframe subset A is designated by a name “ABSsusetPrimary”, and the “absSubset” serving as the second subframe subset B is designated by a name “ABSsusetSecondary”.

The subset information may be included in another message to be transmitted from the base station device to the terminal device, such as RRC Connection Reconfiguration, as well as RRC Connection Setup.

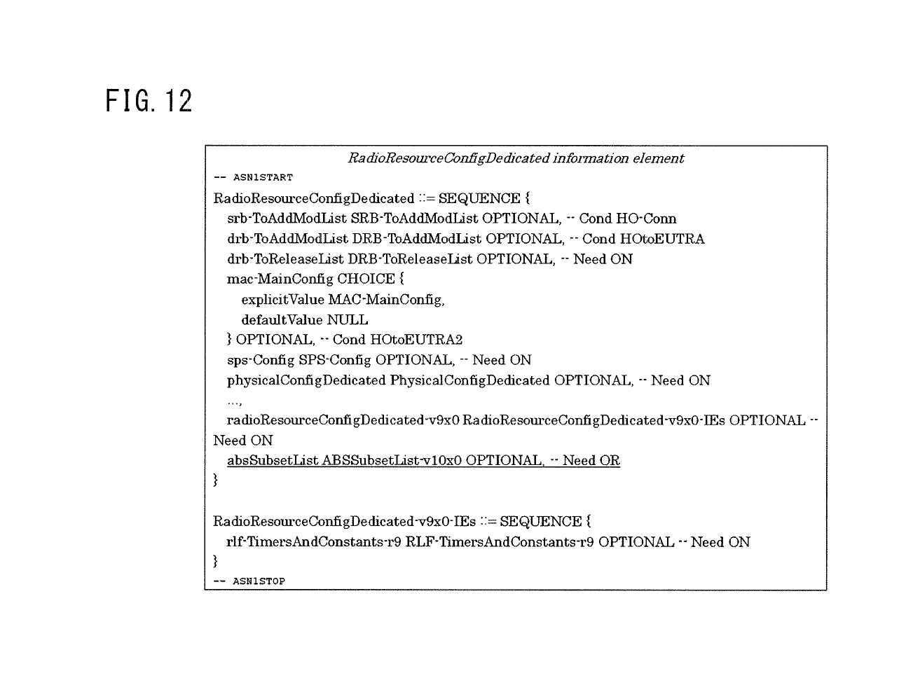

The RRC Connection Setup or the RRC Connection Reconfiguration as a message in radio connection control has “radioResourceConfigDedicated” as a common IE. The “radioResourceConfigDedicated” defines configuration information relating to radio. When including the subset information (“ABSSubsetList-v10x0”) in the RRC Connection Setup or the RRC Connection Reconfiguration, for example, as shown in FIG. 12, the subset information (“ABSSubsetList-v10x0”) shown in FIG. 11 can be stored in the “radioResourceConfigDedicated”.

Addition of subset information is an option. If subset information need not be notified, the subset information is not included in a message.

As described above, according to the present embodiment, even before the base station device acquires a CQI report, an appropriate transmission state is selected. Moreover, information indicating a subframe subset to be subjected to CQI measurement is early notified to the terminal device.

### 6.2 Example 2

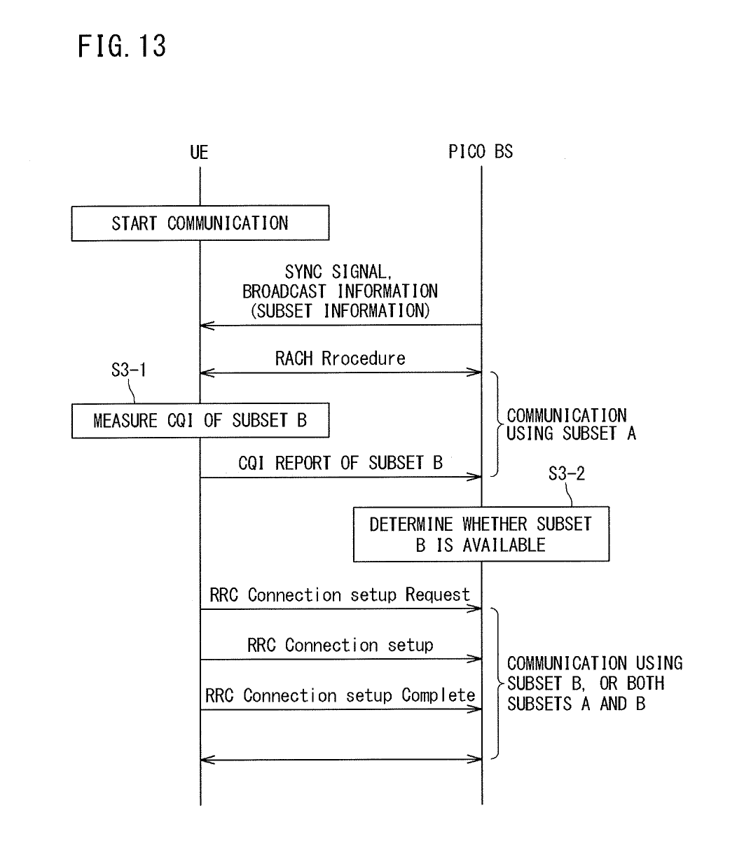

In FIG. 10, the subset information is transmitted, being included in the message of the RRC Connection Setup to be transmitted during the connection establishment process. In Example 2 shown in FIG. 13, subset information is transmitted, being included in system information (SIB) to be transmitted as broadcast information.

Since the subset information is transmitted as broadcast information, the terminal device 2 can acquire the subset information even before performing the connection establishment process (even when the terminal device is in the idle state).

When the connection establishment process is started, the pico BS 1b performs transmission in the first transmission state using the first subframe subset A, before acquiring the CQI report, as in the procedure shown in FIG. 10. That is, RACH Procedure is performed in the first transmission state using only the first subframe subset A.

However, since the terminal device 2 has acquired the subset information before the connection establishment process, when synchronization with the pico BS 1b is achieved by the RACH Procedure, the terminal device 2 can immediately perform CQI measurement by the CQI measurement section 22 (step S3-1).

Accordingly, the state selection section 15 of the pico BS 1b can acquire the CQI report from the terminal device 2, and select either the first transmission state or the second transmission state, in a relatively early stage of the connection establishment process (step S3-2).

That is, the transmission state selection can be performed earlier in the procedure shown in FIG. 13 than in the procedure shown in FIG. 10.

### 6.3 Example 3

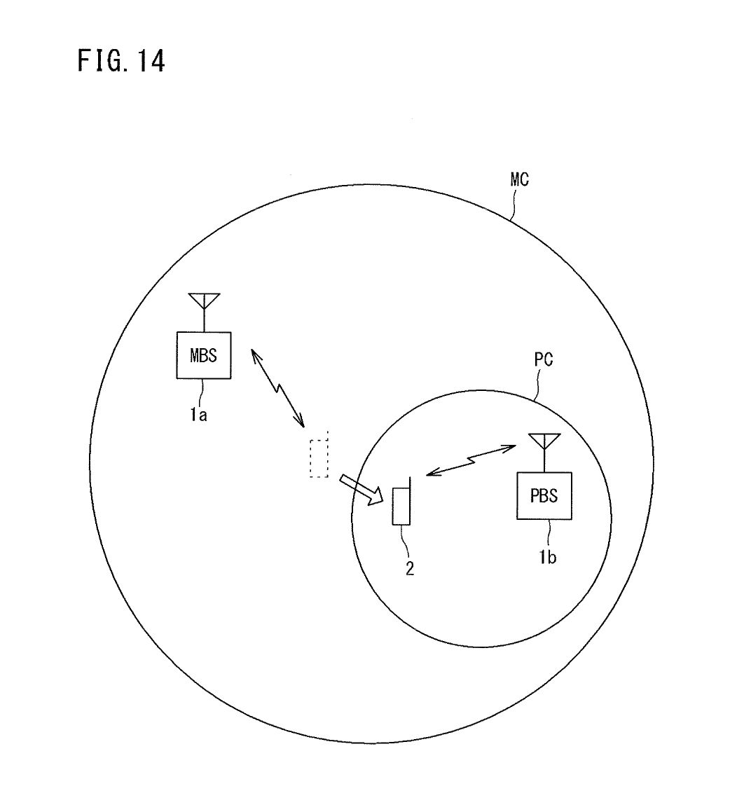

FIGS. 14 to 16 show an example in which notification of subset information to the terminal device 2 is performed during a handover process.

The terminal device 2 starts communication with the macro BS 1a (step S4-1). While the terminal device 2 is communicating with the macro BS 1a (step S4-2), if the terminal device 2 moves into the area PC of the pico BS 1b as shown in FIG. 14 (step S4-3), the macro BS 1a determines whether or not handover of the terminal device 2 from the macro BS 1a to the pico BS 1b is necessary (step S4-4).

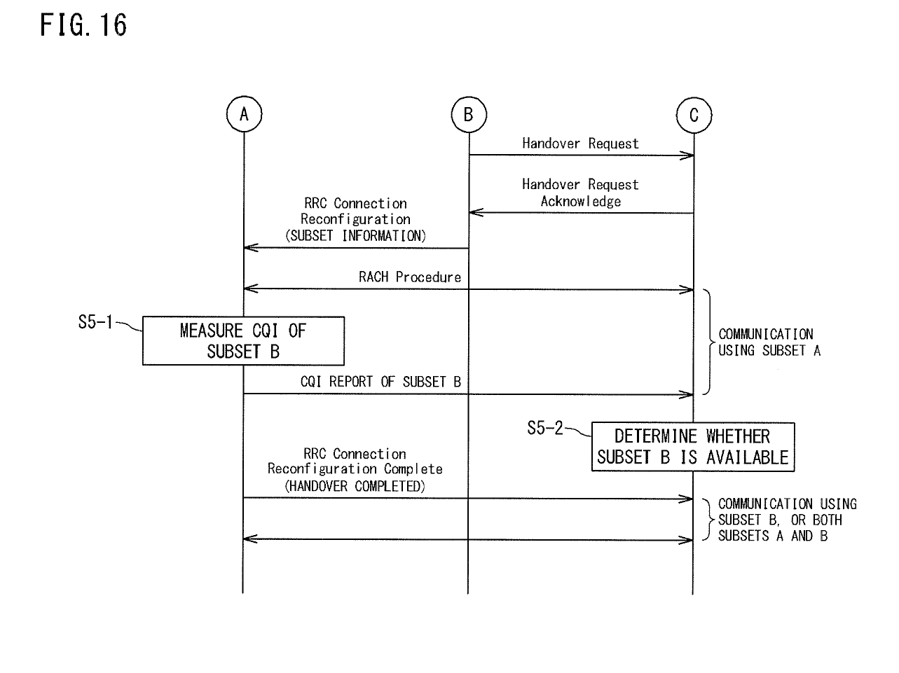

Based on the result of the determination, when it has been determined that handover is necessary, a handover process shown in FIG. 16 is performed.

In advance of the handover process, acquisition of ABS information of the macro BS 1a is performed in the pico BS 1b (step S4-5). The process in step S4-5 is identical to the process in step S1-1 shown in FIG. 8, and various methods as shown in FIG. 9 may be adopted to acquire the ABS information.

As shown in FIG. 16, when the macro BS 1a transmits, for handover, Handover Request to the pico BS 1b, the pico BS 1b returns Handover Request Acknowledge as a response to the Handover Request to the macro BS 1a.

In Example 3, the notification section 13 of the pico BS 1b includes the subset information in Handover Request Acknowledge as a response to Handover Request, to notify the macro BS 1a of the subset information.

The macro BS 1a that has received the subset information notifies the terminal device 2 of RRC Connection Reconfiguration (handover command) which is one of the messages in the handover process. The subset information received by the macro BS 1a is included in the RRC Connection Reconfiguration.

Accordingly, the terminal device 2 that has received the RRC Connection Reconfiguration (handover command) can acquire the subset information.

As described above, in Example 3, the subset information is notified from the pico BS 1b to the terminal device 2 via the macro BS 1a. Moreover, since, during the handover process, the terminal device 2 is communicable not only with the pico BS 1b as a target base station device but also with the macro BS 1a as a source base station device, Example 3 is suitable for notifying the subset information from the pico BS 1b to the terminal device 2 via the macro BS 1a.

In Example 3, like in Example 2, the subset information has been acquired before the RACH Procedure is performed.

Then, the pico BS 1b performs transmission in the first transmission state using the first subframe subset A before acquiring the CQI report. However, since the terminal device 2 has acquired the subset information in advance, like in Example 2, when synchronization with the pico BS 1b has been achieved by the RACH Procedure, the terminal device 2 can immediately perform CQI measurement by the CQI measurement section 22 (step S5-1).

Accordingly, the state selection section 15 of the pico BS 1b can acquire the CQI report from the terminal device 2, and select either the first transmission state or the second transmission state, in a relatively early stage before completion of the handover process (step S5-2).

The embodiment described above is to be considered in all respects as illustrative and not restrictive. The scope of the present invention is indicated by the appended claims rather than by the foregoing meaning, and all changes which come within the meaning and range of equivalency of the claims are therefore intended to be embraced therein.

For example, other base station devices (particularly, small base station devices) such as a femto BS 1c may have the function of the pico BS 1b described according to the present embodiment.

### DESCRIPTION OF THE REFERENCE CHARACTERS

1 base station device (1a: macro base station device, 1b: pico base station device, 1c: femto base station device)
2 terminal device
3 MME
5 gateway
6 S 1 interface
X2 interface
11 ABS information acquisition section
12 pattern selection section
13 subset information notification section
14 CQI report acquisition section
15 state selection section
21 subset information acquisition section
22 CQI measurement section
24 CQI report transmission section
A first subframe subset
B second subframe subset

1. A base station device that performs radio communication with a terminal device, comprising:
a report acquisition section that acquires, from the terminal device, a report relating to a measurement result of communication quality; and
a selection section that selects a transmission state for the terminal device, wherein
the transmission state includes, at least, a first transmission state in which transmission is performed using a first radio resource subset configured to include one or a plurality of radio resources that do not suffer interference from another base station device, and a second transmission state in which transmission is performed using at least a second radio resource subset configured to include one or a plurality of radio resources that are likely to suffer interference from another base station device,
the report acquisition section acquires, from the terminal device, a report relating to a measurement result of communication quality of one or a plurality of radio resource subsets including the second radio resource subset,
when the report is acquired, the selection section selects, based on the report, either the first transmission state or the second transmission state as the transmission state for the terminal device, and
the selection section selects the first transmission state as the transmission state for the terminal device before the report is acquired.

2. The base station device according to claim 1, further including:
a notification section that notifies subset information indicating one or a plurality of the radio resource subsets including the second radio resource subset, wherein
the notification section notifies another base station device of the subset information, the another base station device being able to notify the terminal device of the subset information.

3. The base station device according to claim 1, further including:
a notification section that notifies subset information indicating one or a plurality of the radio resource subsets including the second radio resource subset, wherein
during a handover process in which the terminal device performs handover to the base station device, the notification section notifies a source base station device in the handover process of the subset information.

4. The base station device according to claim 3, wherein
the notification section notifies the source base station device of the subset information by including the subset information in a message to be transmitted to the source base station device for the handover process.

5. The base station device according to claim 4, wherein
the message to be transmitted to the source base station device for the handover process is a response to a handover request transmitted from the source base station device.

6. The base station device according to claim 1, further including:
a notification section that notifies the terminal device of subset information indicating one or a plurality of the radio resource subsets including the second radio resource subset.

7. The base station device according to claim 6, wherein
the notification section transmits the subset information as broadcast information.

8. The base station device according to claim 6, wherein
the notification section notifies the terminal device of the subset information, during a connection establishment process for establishing connection between the terminal device and the base station device.

9. The base station device according to claim 8, wherein
the notification section notifies the terminal device of the subset information by including the subset information in a message that is transmitted from the base station device to the terminal device in order to establish connection between the terminal device and the base station device.

10. The base station device according to claim 1, wherein
in the second transmission state, transmission is performed by using the first radio resource subset and the second radio resource subset.

11. The base station device according to claim 1, wherein
the radio resource is a time resource or a frequency resource.

12. The base station device according to claim 1, wherein
the radio resource is a subframe or a carrier.

13. A terminal device that performs radio communication with a base station device, comprising:
a measurement section that measures communication quality of a radio resource subset configured to include one or a plurality of radio resources that are likely to suffer interference from another base station device;
a transmission section that transmits, to the base station device, a report relating to a measurement result by the measurement section; and
a subset information acquisition section that acquires subset information indicating a radio resource subset whose communication quality should be measured by the measurement section.

14. The terminal device according to claim 13, wherein
the acquisition section acquires the subset information from the another base station device.

15. The terminal device according to claim 13, wherein
the acquisition section acquires the subset information from a source base station device in a handover process.

16. The terminal device according to claim 13, wherein
the subset information is included in broadcast information transmitted from the base station device, and
the subset information acquisition section acquires the subset information by receiving the broadcast information from the base station device.

17. The terminal device according to claim 16, wherein
the measurement section measures communication quality of a radio resource subset indicated by the subset information included in the broadcast information that has been received in advance of a connection establishment process for establishing connection between the terminal device and the base station device, and
the transmission section transmits the report during the connection establishment process.

18. The terminal device according to claim 13, wherein
the subset information is included in a message that is transmitted from the base station device to the terminal device in order to establish connection between the terminal device and the base station device, and
the subset information acquisition section acquires the subset information by receiving the message from the base station device.

19. A radio communication system including a base station device, and a terminal device that performs radio communication with the base station device, wherein
the base station device includes: a report acquisition section that acquires, from the terminal device, a report relating to a measurement result of communication quality; and a selection section that selects a transmission state for the terminal device,
the transmission state includes, at least, a first transmission state in which transmission is performed using a first radio resource subset configured to include one or a plurality of radio resources that do not suffer interference from another base station device, and a second transmission state in which transmission is performed using at least a second radio resource subset configured to include one or a plurality of radio resources that are likely to suffer interference from another base station device,
the report acquisition section acquires, from the terminal device, a report relating to a measurement result of communication quality of one or a plurality of radio resource subsets including the second radio resource subset,
when the report is acquired, the selection section selects, based on the report, either the first transmission state or the second transmission state as the transmission state for the terminal device, and
the selection section selects the first transmission state as the transmission state for the terminal device before the report is acquired.

20. The radio communication system according to claim 19, wherein
the base station device further includes a notification section that notifies subset information indicating one or a plurality of the radio resource subsets including the second radio resource subset,
the notification section notifies another base station device of the subset information, the another base station device being able to notify the terminal device of the subset information, and
the another base station device notifies the terminal device of the subset information.

21. A method performed by a base station device to select a transmission state, wherein
the transmission state includes, at least, a first transmission state in which transmission is performed using a first radio resource subset configured to include one or a plurality of radio resources that do not suffer interference from another base station device, and a second transmission state in which transmission is performed using at least a second radio resource subset configured to include one or a plurality of radio resources that are likely to suffer interference from another base station device, and
the base station device
selects the first transmission state as a transmission state for the terminal device before acquiring, from the terminal device, a report relating to a measurement result of communication quality of one or a plurality of radio resource subsets including the second radio resource subset, and
upon acquiring the report, selects, based on the report, either the first transmission state or the second transmission state as the transmission state for the terminal device.

22. A method for transmitting information from a base station device to a terminal device, wherein
the information is subset information indicating a radio resource subset configured to include one or a plurality of radio resources to be a target of measurement of communication quality by the terminal device,
the base station device notifies another base station device of the subset information, the another base station device being able to notify the terminal device of the subset information, and
the another base station device transmits the subset information to the terminal device.
